(19) United States
(12) Patent Application Publication
(10) Pub. No.: US 2006/0185249 A1
(43) Pub. Date: Aug. 24, 2006

(54) Roof vent

(75) Inventors: John H. Whittlesea, Northants (GB); Simon C. Blaney, Leicester (GB)

Correspondence Address: Stephen B. Salai, Esq.;Harter, Secrest & Emery LLP, 1600 Bausch & Lomb Place, Rochester, NY, 14604-2711, US

(73) Assignee: Accuride International Limited, Northampton (GB)

(21) Appl. No.: 11/359,658

(22) Filed: Feb. 22, 2006

(30) Foreign Application Priority Data
Feb. 23, 2005 (GB) 0503718.9

(51) Int. Cl. E05B 65/06

(52) U.S. Cl. 49/402; 49/394

(57) ABSTRACT

The present invention relates to roof vents and particularly roof vents which can be slid relative to the roof on which they are mounted. The roof vent has a simple mechanism, and is sealable to prevent the ingress of water through the roof vent.

### CROSS-REFERENCE TO RELATED APPLICATIONS

This application claims priority of United Kingdom patent application number 05031718.9 filed Feb. 23, 2005.

### BACKGROUND OF THE INVENTION

The concept of a roof vent is well known. A window is provided in a roof in order to allow light to enter a room through the roof. The window may be openable in order to provide ventilation to the room in which the roof vent is provided.

Known prior art openable roof vents are mounted to a frame at one end by a set of hinges. In order to open the roof vent, it is pivoted about the set of hinges and propped open at its opposite end. The opposite end may be provided with a winding gear mechanism which can be used to move the vent from its closed to its open position. By providing a winding gear, the extent to which the vent is opened can be controlled.

Generally a roof vent system will consist of a frame mounted in a hole in the roof, and a separate sash frame positioned to cover the frame mounted in the roof when the vent is in its closed position. In order to prevent rain entering the building through the roof vent, the roof mounted frame may include upstanding edges which protrude above the plane of the roof, and the sash frame may include downturned edges which fit around the upstanding edges of the roof mounted frame. Since the upstanding edges fit inside the downturned edges, it is not possible to slide the sash frame relative to the roof mounted frame.

### BACKGROUND ART

WO91/19070 discloses a roof vent system in which a sash frame is supported in the roof frame via four legs attached near each corner of the sash frame. Each leg carries a roller which is captive in a straight guide track. The legs are swivellably mounted to the sash frame to enable the sash frame to be lifted away from the roof frame, the legs rotating about the rollers located in the guide track. As the roof vent is closed, the rollers come into contact with a stop in the guide tracks, forcing the leg to rotate about the fixed roller which pulls the sash down towards the roof frame. In order to open the roof vent, a latch is released which releases a spring attached to each leg. The springs force the legs to rotate about the rollers which in turn raises the sash frame away from the roof frame. The rollers can then roll along the guide tracks in order to open the roof vent.

### BRIEF SUMMARY OF THE INVENTION

The present invention seeks to provide a roof vent which can be slid relative to the roof on which it is mounted, which has a simple mechanism, and which is sealable to prevent the ingress of water through the roof vent.

According to the present invention, there is provided a roof vent comprising:
a first frame having an opening and an upstanding wall around at least a part of the opening,
a sash frame mounted on the first frame, the sash frame having a downturned wall, and being movable from a first position in which the sash frame closes the opening in the first frame in a watertight manner, to a second position in which at least a part of the sash frame is raised above the upstanding wall of the first frame, and
a slide having a first portion mounted on the first frame and a second portion connected to the sash frame via at least one connector,
the at least one connector being shaped to interact with a first part of the first frame such that:
movement of the second portion of the slide relative to the first portion of the slide in a first direction causes the connector to move over the first part of the first frame and at least a portion of the sash frame to be raised above the upstanding wall, and further movement in the first direction causes the sash frame to slide relative to the first frame to open the vent; and
movement of the second portion of the slide relative to the first portion of the slide in a second direction causes the sash frame to slide relative to the first frame to close the vent and further movement in the second direction causes the connector to move over the first part of the first frame and at least a portion of the sash frame to be lowered.

The first frame may have a first pair of upstanding walls and a second pair of upstanding walls and the first portion of the slide may be mounted on one of the first pair of upstanding walls.

The sash frame may have a first pair of downturned walls and a second pair of downturned walls and the second portion of the slide may be mounted on one of the first pair of downturned walls.

The distance between each of the first pair of downturned walls may be larger than the distance between each of the first pair of upturned walls so that the sash frame fits over the frame.

The second portion of the slide may be pivotally mounted on the sash frame, and initial movement of the second portion of the slide relative to the first portion of the slide may cause the sash frame to pivot. The second portion of the slide may be pivotally mounted on the downturned wall.

The sash frame may be connected to the second portion of the slide at its second end via the connector at a first end and pivotally connected to the downturned wall at a second end, such that upon movement of the second portion of the slide relative to the first portion of the slide, the sash frame moves in a radial direction defined by the pivot point.

Alternatively, the sash frame may be connected to the second portion of the slide via a connector at each end, such that upon movement of the second portion of the slide relative to the first portion of the slide, both ends of the sash frame are raised above the upstanding wall of the first frame.

The or each connector may be pivotally connected to the second portion of the slide. The or each connector may also be pivotally connected to a slider which slidably communicates with the sash frame. The connector at each end of the second portion of the slide may be pivotally connected to its own slider which slidably communicates with the sash frame. Alternatively, the connectors at each end of the second portion of the slide may be pivotally connected to the same slider which slidably communicates with the sash frame. The sash frame may be provided with a channel in which the or each slider is mounted. Each slider may be mounted in its own channel. The or each slider may be a “T” shaped piece and the or each channel may be shaped to house the “T” shaped slider. The slider may be formed of a plastics material.

The connector may have a first camming surface at a first end thereof, and the first part of the first frame may have a second camming surface for interacting with the first camming surface on the connector.

One of the first and second camming surfaces may comprise a projection and the other of the first and second camming surfaces may comprise a corresponding indentation.

The connector may be pivotally connected to the second portion of the slide, and further pivotally connected to a slider which slidably communicates with a channel in the sash frame. In this case, interaction of the camming surfaces causes the connector to rotate about its pivotal connection with the second portion of the slide, and causes the slider to slide in the channel in the sash frame.

The second portion of the slide may be provided with at least one rotation stop for limiting the extent of the rotation of the or each connector.

In order to move the sash frame relative to the first frame, the roof vent may be provided with means for pushing on the sash frame in a direction parallel to a length of the first portion of the slide.

The means may comprise a flexible leadscrew having a first end connected to the sash frame.

The roof vent may further comprise an actuating mechanism for driving the flexible leadscrew against the sash frame. The actuating mechanism may comprise a rotatable handle having a worm gear for meshing with the flexible leadscrew. Alternatively, the actuating mechanism may comprise a motor having a worm gear for meshing with the flexible leadscrew. The motor may be operated with a remote control device.

### BRIEF DESCRIPTION OF THE DRAWINGS

A preferred embodiment of the present invention will now be described in detail with reference to the following drawings in which:

FIG. 1 shows a plan view of a roof vent according to the present invention;

FIG. 2 shows a cut-away view through the line A-A of the roof vent shown in FIG. 1;

FIG. 3 shows a detail of the section marked “A” in FIG. 2;

FIG. 4 shows a side view of a roof vent according to the present invention;

FIG. 5 shows a detail of the section marked “B” in FIG. 4; and

FIG. 6 shows a view of the roof vent in an open position.

### DETAILED DESCRIPTION OF THE INVENTION

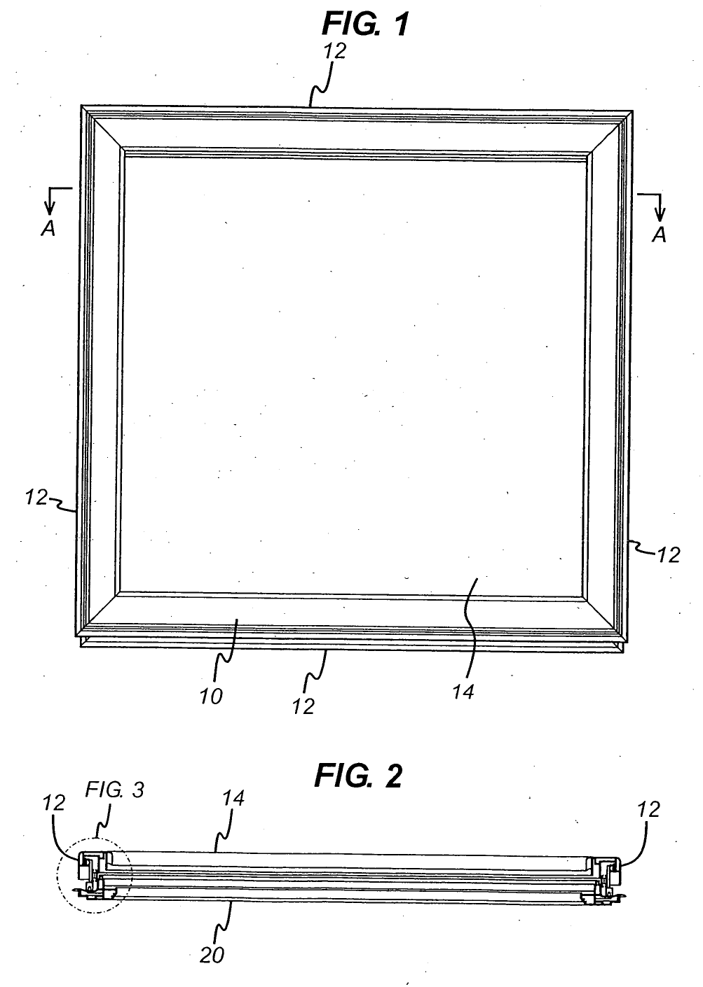

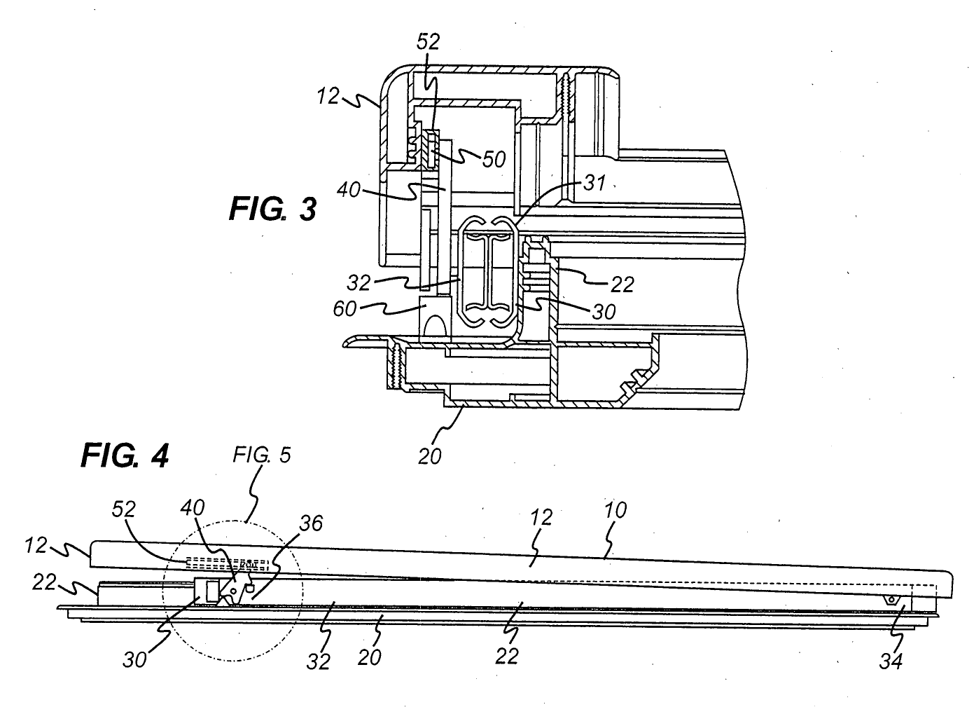

As can be seen from FIGS. 1 to 6, a roof vent according to an embodiment of the present invention comprises a sash frame 10 which has four downturned side walls 12 extending perpendicularly to a window 14 mounted within the sash frame 10. The roof vent also comprises a roof-mountable frame 20 which has four upstanding side walls 22 extending perpendicularly to the plane of the roof in which the roof-mountable frame is to be mounted. The distance between two opposed side walls 12 of the sash frame 10 is larger than the distance between two opposed side walls 22 of the roof-mountable frame 20. Consequently, the sash frame can be positioned over the roof-mountable frame so that any water running down the roof in which the vent is to be fixed does not enter the building through the roof vent. Instead, the water is diverted around the bottom of the side walls 22 of the roof-mountable frame 20.

A first portion 31 of a slide 30 is mounted to a side wall 22 of the roof-mountable frame and is fixed stationary relative to the roof-mountable frame. A second portion 32 of the slide 30 is pivotally connected at a first end 34 thereof to the sash frame 10. A second end 36 of the second portion 32 of the slide 30 is pivotally connected to a connector portion 40 at a pivot point 38.

A first end 41 of the connector 40 is connected to a plastic “T” shaped slider 50 which is mounted within a correspondingly shaped channel 52 on a side wall 12 of the sash frame 10.

A second end 42 of the connector 40 is shaped to form a camming surface 44 which is shaped to interact with a corresponding camming surface 46 on a stationary block 60 mounted on the roof-mountable frame 20.

A side of the connector 40 is provided with a notch 48 which is shaped to abut against a rotation stop 70 formed in the second portion 32 of the slide 30.

An end of a flexible leadscrew 80 is affixed to the sash frame. The leadscrew extends through the opening in the centre of the roof-mountable frame and meshes with a worm gear (not shown). The worm gear may be connected to an actuating handle which can be used to turn the worm gear. Alternatively, the worm gear may be attached to a motor which can be used to drive the worm gear. The motor could be controlled with a remote control if required.

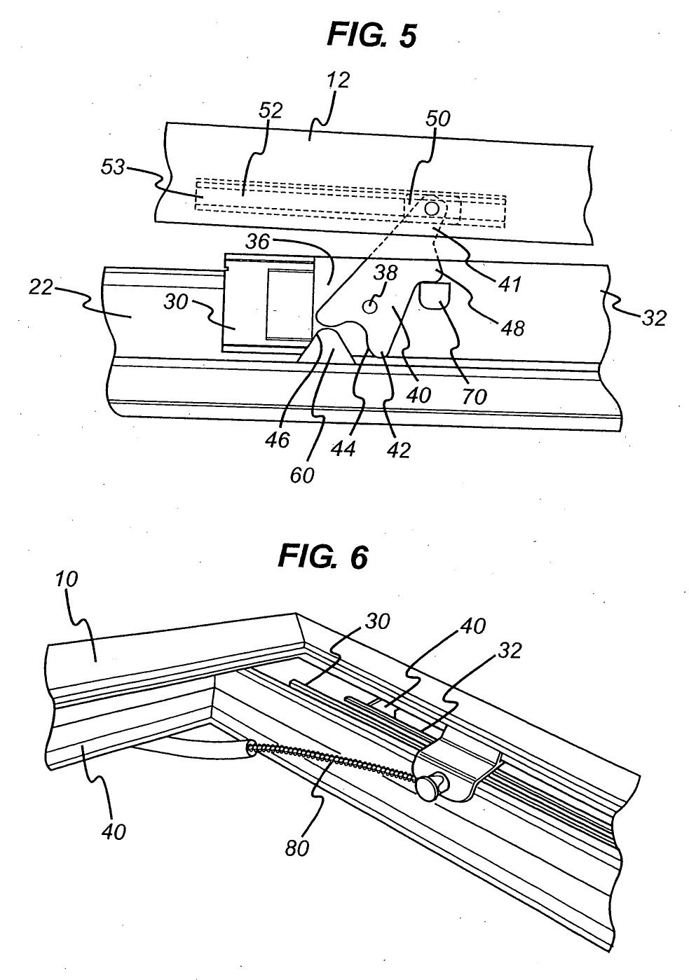

In use, when the roof vent is in a closed position, the sash frame 10 is positioned over the roof-mountable frame so that the window 14 is parallel to the roof in which the vent is mounted. The “T” shaped slider 50 is positioned close to the first end 53 of the channel 52 and the connector 40 is rotated into an opposite position to that shown in FIG. 5.

In order to open the vent, the worm gear is turned, and the flexible leadscrew is driven so that it exerts a force against the sash frame 10 which attempts to slide the sash frame 10 relative to the roof-mountable frame 20. However, once the sash frame has begun to slide, the connector 40 strikes the stationary block 60, and the camming surfaces 44 and 46 interact with one another so as to rotate the connector about the pivot point 38 and slide the slider 50 along the channel 52 until the slider and connector reach the position shown in FIG. 5. Movement of the connector is halted when the notch 48 strikes the rotation stop 70.

In moving the connector 40 from the closed position to the position shown in FIG. 5, the sash frame pivots about the pivot point at the first end 34 of the second portion 32 of the slide, and the opposite end of the sash frame is raised upwards so that it is positioned above the roof-mountable frame as shown in FIG. 4.

Further rotation of the worm gear pushes the sash frame 10 so that the second portion 32 of the slide 30 slides relative to the first portion 31 of the slide 30 and consequently the sash frame 10 slides relative the roof-mountable frame 20. By rotating the worm gear further, the vent can be opened to any desired extent.

In order to close the vent, the worm gear is rotated in the opposite direction and the slide and connector are returned to their closed positions.

The roof vent of the present invention clearly offers a number of advantages over those of the prior art. In particular, the sash can be slid away from the vent area thus providing a large area for ventilation. However, when the sash is returned to its closed position, a seal is provided so that water cannot leak around the edge of the vent.

The slides used in the roof vent of the present invention can be standard slides. Consequently, the present invention uses readily available and economical parts.

It will of course be understood that the present invention has been described above purely by way of example, and that modifications of detail can be made within the scope of the invention as defined by the following claims.

1. A roof vent comprising:
a first frame having an opening and an upstanding wall around at least a part of the opening,
a sash frame mounted on the first frame, the sash frame having a downturned wall, and being movable from a first position in which the sash frame closes the opening in the first frame in a watertight manner, to a second position in which at least a part of the sash frame is raised above the upstanding wall of the first frame, and
a slide having a first portion mounted on the first frame and a second portion connected to the sash frame via at least one connector,
the at least one connector being shaped to interact with an engagement element of the first frame such that:
movement of the second portion of the slide relative to the first portion of the slide in a first direction causes the connector to move over the engagement element of the first frame and at least a portion of the sash frame to be raised above the upstanding wall, and further movement in the first direction causes the sash frame to slide relative to the first frame to open the vent; and
movement of the second portion of the slide relative to the first portion of the slide in a second direction causes the sash frame to slide relative to the first frame to close the vent and further movement in the second direction causes the connector to move over the engagement element of the first frame to lower said sash frame.

2. The roof vent of claim 1, wherein the first frame has a first pair of upstanding walls and a second pair of upstanding walls and wherein the first portion of the slide is mounted on one of the first pair of upstanding walls.

3. The roof vent of claim 2, wherein the sash frame has a first pair of downturned walls and a second pair of downturned walls and wherein the second portion of the slide is connected to on one of the first pair of downturned walls via the at least one connector.

4. The roof vent of claim 3, wherein the distance between each of the first pair of downturned walls is larger than the distance between each of the first pair of upturned walls so that the sash frame fits over the frame.

5. The roof vent of claim 1, wherein the second portion of the slide is pivotally mounted on the sash frame, and initial movement of the second portion of the slide relative to the first portion of the slide causes the sash frame to pivot relative to the second portion of the slide.

6. The roof vent of claim 5 wherein the second portion of the slide is pivotally mounted on the downturned wall.

7. The roof vent of claim 5, wherein the sash frame is connected to the second portion of the slide via the connector at a first end and pivotally connected to the downturned wall at a second end, such that upon movement of the second portion of the slide relative to the first portion of the slide, the sash frame moves in a radial direction defined by the pivot point.

8. The roof vent of claim 1, wherein the sash frame is connected to the second portion of the slide via a connector at each end, such that upon movement of the second portion of the slide relative to the first portion of the slide, both ends of the sash frame are raised above the upstanding wall of the first frame.

9. The roof vent of claim 7 wherein the or each connector is pivotally connected to the second portion of the slide.

10. The roof vent of claim 8 wherein the or each connector is pivotally connected to the second portion of the slide.

11. The roof vent of claim 7 wherein the or each connector is pivotally connected to a slider which slidably communicates with the sash frame.

12. The roof vent of claim 8 wherein the or each connector is pivotally connected to a slider which slidably communicates with the sash frame.

13. The roof vent of claim 12 wherein each connector is pivotally connected to its own slider which slidably communicates with the sash frame.

14. The roof vent of claim 12 wherein the connectors at each end of the second portion of the slide are pivotally connected to the same slider which slidably communicates with the sash frame.

15. The roof vent of claim 11 wherein the sash frame is provided with a channel in which the or each slider is mounted.

16. The roof vent of claim 12 wherein the sash frame is provided with a channel in which the or each slider is mounted.

17. The roof vent of claim 15 wherein the sash frame is provided with more than one channel, wherein each slider is mounted in a different one of the channels.

18. The roof vent of claim 16 wherein the sash frame is provided with more than one channel, wherein each slider is mounted in a different one of the channels.

19. The roof vent of claim 11, wherein the or each slider is a “T” shaped piece.

20. The roof vent of claim 12, wherein the or each slider is a “T” shaped piece.

21. The roof vent of claim 15 wherein the or each slider is a “T” shaped piece and the or each channel is shaped to house the “T” shaped slider.

22. The roof vent of claim 16 wherein the or each slider is a “T” shaped piece and the or each channel is shaped to house the “T” shaped slider.

23. The roof vent of claim 11 wherein the slider is formed of a plastics material.

24. The roof vent of claim 12 wherein the slider is formed of a plastics material.

25. The roof vent of claim 1 wherein the connector has a first camming surface at a first end thereof, and the engagement element of the first frame has a second camming surface for interacting with the first camming surface on the connector.

26. The roof vent of claim 25 wherein one of the first and second camming surfaces comprises a projection and the other of the first and second camming surfaces comprises a corresponding indentation.

27. The roof vent of claim 25 wherein the connector is pivotally connected to the second portion of the slide, and further pivotally connected to a slider which slidably communicates with a channel in the sash frame, and wherein interaction of the camming surfaces causes the connector to rotate about its pivotal connection with the second portion of the slide, and causes the slider to slide in the channel in the sash frame.

28. The roof vent of claim 1 wherein the second portion of the slide is provided with at least one rotation stop for limiting the extent of the rotation of the or each connector.

29. The roof vent of claim 1, further comprising means for pushing on the sash frame in a direction parallel to a length of the first portion of the slide.

30. The roof vent of claim 29 wherein the means comprises a flexible leadscrew having a first end connected to the sash frame.

31. The roof vent of claim 30 further comprising an actuating mechanism for driving the flexible leadscrew against the sash frame.

32. The roof vent of claim 31 wherein the actuating mechanism comprises a rotatable handle having a worm gear for meshing with the flexible leadscrew.

33. The roof vent of claim 32 wherein the actuating mechanism comprises a motor having a worm gear for meshing with the flexible leadscrew.

34. The roof vent of claim 33 further comprising a remote control device for operating the motor.
